(19) United States
(12) Patent Application Publication
(10) Pub. No.: US 2025/0182539 A1
(43) Pub. Date: Jun. 5, 2025

(54) SIDE SLIP ANGLE ESTIMATION DEVICE AND METHOD

(71) Applicant: HL MANDO CORPORATION, Gyeonggi-do (KR)

(72) Inventor: Kyungtack LEE, Gyeonggi-do (KR)

(21) Appl. No.: 18/827,754

(22) Filed: Sep. 8, 2024

(30) Foreign Application Priority Data
Dec. 1, 2023 (KR) 10-2023-0172557

(51) Int. Cl. G07C 5/08

(52) U.S. Cl. CPC G07C 5/0808

(57) ABSTRACT

A device and method of estimating a side slip angle calculate a final estimated value of the side slip angle by mixing a side slip angle estimated based on dynamics and a side slip angle change rate estimated based on kinematics using a Kalman filter, so that an error in an estimation value of the side slip angle due to nonlinear characteristics of a vehicle may be reduced and robustness may be increased even when there is a failure or error in a vehicle sensor.

### CROSS-REFERENCE TO RELATED APPLICATION

This application claims priority to and the benefit of Korean Patent Application No. 2023-0172557, filed on Dec. 1, 2023, the disclosure of which is incorporated herein by reference in its entirety.

### BACKGROUND

### 1. Field

The present disclosure generally relates to lateral stability control of a vehicle, and in particular, to a device, method, and computer readable medium for estimating a side slip angle for lateral stability control of a vehicle.

### 2. Discussion of Related Art

Suspensions connecting a vehicle body and wheels may be devices necessary to absorb road shock and secure tire traction at the same time. The suspension plays a role in absorbing shock generated while the vehicle is traveling on a road before the shock is transmitted to the vehicle body or an occupant, thereby reducing fatigue of the vehicle body to increase durability and preserving ride quality of the occupant.

The suspension may need to be controlled in order to control lateral stability of the vehicle. That is, the height or damping force of the suspension may be adjusted, and for this purpose, accurate estimation of a side slip angle may be needed.

### SUMMARY

Some embodiments of the present disclosure may be directed to providing a side slip angle estimation device and method configured to complement a dynamics-based side slip angle estimation method.

Certain embodiments of the present disclosure may be directed to improving the accuracy of a side slip angle estimation method by combining dynamics-based estimation and kinematics-based estimation.

Meanwhile, other objects not mentioned in the present disclosure will be additionally considered within the scope to be easily inferred from the following detailed description and effects thereof.

According to an aspect of the present disclosure, there is provided a side slip angle estimation device including a dynamics-based estimator configured to estimate a side slip angle of a vehicle using a vehicle sensor value based on dynamics, a kinematics-based estimator configured to estimate a side slip angle change rate of the vehicle using the vehicle sensor value based on kinematics, and a mixed estimator configured to estimate a final side slip angle using the side slip angle estimated by the dynamics-based estimator and the side slip angle change rate estimated by the kinematics-based estimator.

The dynamics-based estimator may estimate the side slip angle by a sliding mode observer.

The dynamics-based estimator may estimate the side slip angle by a Kalman filter.

The kinematics-based estimator may calculate the side slip angle change rate based on a speed of the vehicle in a direction of travel, an acceleration of the vehicle in a direction perpendicular to the direction of travel, and a yaw rate of the vehicle.

The kinematics-based estimator may calculate a value obtained by subtracting the yaw rate from a value obtained by dividing the acceleration of the vehicle in the direction perpendicular to the direction of travel by the speed of the vehicle in the direction of travel as the side slip angle change rate.

The mixed estimator may estimate the final side slip angle using a side slip angle change rate obtained by mixing a dynamic side slip angle change rate estimated by the dynamics-based estimator and a kinematic side slip angle change rate estimated by the kinematics-based estimator.

The mixed estimator may estimate the final side slip angle by a Kalman filter.

The mixed estimator may use a dynamic side slip angle and a dynamic side slip angle change rate calculated by a sliding mode observer as measurement values to be used in the Kalman filter.

The mixed estimator may use the side slip angle change rate calculated by the kinematics-based estimator when a state space equation model of the Kalman filter is updated, instead of a final side slip angle change rate calculated in a previous operation.

The mixed estimator may estimate the final side slip angle using a side slip angle change rate obtained by mixing a dynamic side slip angle change rate estimated by the dynamics-based estimator and a kinematic side slip angle change rate estimated by the kinematics-based estimator when a state space equation model of the Kalman filter is updated, instead of a final side slip angle change rate calculated in a previous operation.

According to another aspect of the present disclosure, there is provided a side slip angle estimation method including estimating a side slip angle of a vehicle using a vehicle sensor value based on dynamics, estimating a side slip angle change rate of the vehicle using the vehicle sensor value based on kinematics, and estimating a final side slip angle using the side slip angle estimated based on the dynamics and the side slip angle change rate estimated based on the kinematics.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a schematic structural diagram of a side slip angle estimation device according to an exemplary embodiment of the present disclosure;

FIG. 2 is graphs comparing side slip angle estimation results by a side slip angle estimation device according to an exemplary embodiment of the present disclosure and side slip angle estimation results by vehicle simulation.

FIG. 3 is a table comparing side slip angle estimation results by a side slip angle estimation device according to an exemplary embodiment of the present disclosure and actual measured side slip angles of a vehicle;

FIGS. 4 and 5 are graphs comparing the side slip angle estimation results by the side slip angle estimation device according to the exemplary embodiment of the present disclosure and the actual measured side slip angles of the vehicle; and

FIG. 6 is a schematic flowchart of a side slip angle estimation method according to another exemplary embodiment of the present disclosure.

It is clarified that the attached drawings are illustrated as a reference for understanding the technical concept of the present invention, and the scope of the present invention is not limited by the drawings.

### DETAILED DESCRIPTION OF EXEMPLARY EMBODIMENTS

The objects and means of the present invention and advantages according thereto will be more obvious from the following detail descriptions with reference to the accompanying drawings, and accordingly, the technical concept of the present invention may be easily practiced by those skilled in the art to which the present invention pertains. In describing the present invention, when it is determined that the detailed description of the known technology related to the present invention may unnecessarily obscure the subject matter of the present invention, the detailed description thereof will be omitted.

The terms used in the present specification are for the purpose of describing the embodiments only and are not intended to limit the invention. In the present specification, the singular forms “a,” “an,” and “the” are intended to include the plural forms as well as appropriate, unless the context clearly indicates otherwise. In this specification, terms such as “comprise,” “include,” “provide,” or “have” do not exclude the presence or addition of one or more other components other than mentioned components.

In the present specification, terms such as “or” and “at least one” may represent one of words listed together, or a combination of two or more. For example, “A or B” and “at least one of A and B” may include only A or B, or include both A and B.

In the present specification, the description following “for example” may not exactly match the information presented, such as the recited characteristics, variables or values, and the exemplary embodiments of the disclosure according to various examples of the present disclosure should not be limited to effects such as variations including tolerances, measurement errors, limitations of measurement accuracy and other commonly known factors.

In the present specification, it will be understood that when an element is described as being “coupled” or “connected” to another element, the element may be directly coupled or connected to the other element, or intervening elements may also be present. In contrast, it will be understood that when an element is referred to as being “directly coupled” or “directly connected” to another element, there are not intervening elements present.

In the present specification, it will be understood that when an element is described as being “on” or “adjacent to” another element, the element may be directly in contact with or connected to another component, or still another component may exist therebetween. In contrast, it may be understood that when an element is described as being “directly above” or “directly adjacent to” another component, still another component does not exist therebetween. Other expressions describing the relationship between elements, such as “between” and “directly between,” may be interpreted in the same manner.

In the present disclosure, it will be understood that, although the terms “first,” “second,” etc. may be used to describe various elements, these elements should not be limited by these terms. In addition, the above terms should not be interpreted as limiting the order of each component, and may be used for the purpose of distinguishing one element from another element. For example, a “first element” may be named a “second element,” and similarly, a “second element” may also be named a “first element.”

Unless otherwise defined, all terms used in the present specification may be used as the same meaning as commonly understood by one of ordinary skill in the art to which the present invention pertains. In addition, it will be further understood that terms, such as those defined in commonly used dictionaries, will not be interpreted in an idealized or overly formal sense unless expressly so defined herein.

Hereinafter, one exemplary embodiment according to the present disclosure will be described in detail with reference to the accompanying drawings.

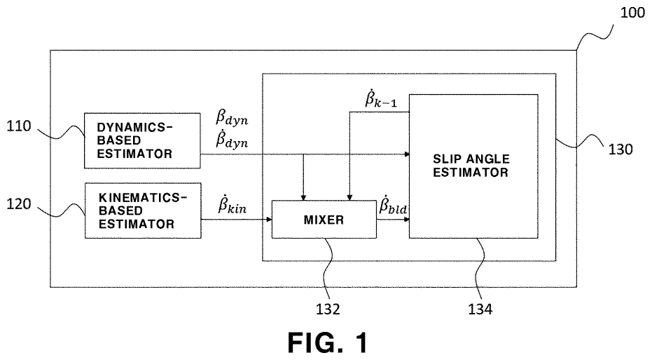

FIG. 1 is a schematic diagram of a side slip angle estimation device according to an exemplary embodiment of the present disclosure.

A side slip angle estimation device 100 according to an exemplary embodiment of the present disclosure may include a dynamics-based estimator or dynamics-based estimation module 110, a kinematics-based estimator or kinematics-based estimation module 120, and a mixed estimator or mixed estimation module 130.

To this end, the side slip angle estimation device 100 may include a controller including one or more processors and a memory.

The controller including one or more processors and a memory may be configured to predict a side slip angle of a vehicle by the dynamics-based estimator 110, the kinematics-based estimator 120, and the mixed estimator 130.

The memory may be configured to store various information necessary for operations of the controller. The information stored in the memory may include various sensor values measured through various sensors included in or associated with the vehicle, information for control operations of the controller, information on signals processed or analyzed by the controller, program information regarding a control method, and the like, but not limited thereto.

For example, the memory may include a hard disk type, a magnetic media type, a compact disc read-only memory (CD-ROM) type, an optical media type, a magneto-optical media type, a multimedia card micro type, a flash memory type, a read-only memory type, a random-access memory type, or the like depending on its type, but not limited thereto. In addition, the memory may be a cache, buffer, main memory, auxiliary memory, or a separately provided storage system depending on its purpose/location, but not limited thereto.

The controller may perform various control operations of the side slip angle estimation device 100. For example, the controller may control signal processing and analysis of sensor values such as a speed, acceleration, yaw rate, and steering angle of the vehicle received from the sensors of the vehicle and the like, and estimate the side slip angle of the vehicle through the signal processing and analysis of the sensor values. For example, the controller may include a hardware processor, a software process executed on the processor, or the like, but not limited thereto.

The dynamics-based estimator 110 estimates a side slip angle β_{dyn} and a side slip angle change rate \dot{β}_{dyn} based on dynamics by sensor values measured using one or more sensors of the vehicle.

The dynamics-based estimator 110 estimates the side slip angle β_{dyn} based on a dynamic model including lateral and longitudinal tire forces of the vehicle. The dynamic model used in the dynamics-based estimator 110 may include, for example, but not limited to, a sliding mode observer (SMO), a Kalman filter, or the like. The sliding mode observer may increase the robustness of estimation even when values such as a yaw rate or lateral acceleration measured by vehicle sensors are noisy.

Because the dynamic model is calculated at a certain point in time, the dynamic model may not accumulating errors and may have a fast update speed. In addition, because the dynamic model may use a linear tire model, the dynamic model exhibits better performance in areas where the movement of the vehicle is linear, such as when the vehicle is driving at low speed or when a steering angle of the vehicle is gentle. However, estimation performance may deteriorate in nonlinear areas where the side slip angle increases, the dynamic model may have limitations.

In order to overcome the limitations, the unscented Kalman filter or the 7DOF vehicle model and the longitudinal force of the tires may be used. However, using a nonlinear model or tuning a nonlinear model may be required according to the vertical force, longitudinal force, and tire slip angle of the tire, and in order to calculate and optimize the nonlinear model or tune the nonlinear model, that the amount of calculation and costs may increases occur.

Therefore, some embodiments of the present disclosure may use kinematics-based estimation to overcome the limitations of the dynamics-based estimator.

The kinematics-based estimator 120 according to certain embodiments of the present disclosure estimates a heading angle and yaw angle of the vehicle using a Global Positioning System (GPS) or an Inertial Measurement Unit (IMU) and estimates the side slip angle change rate \dot{β}ₖᵢₙ based on the heading angle and the yaw angle of the vehicle.

Kinematics-based estimation exhibits better performance despite the nonlinearity of tires even at high vehicle speeds. However, the performance of the Kinematics-based estimation may deteriorate due to integration errors and a slow update rate of the GPS.

Therefore, in some embodiments of the present disclosure, the side slip angle estimation device is configured to compensate for shortcomings of each of the estimation methods by predicting a final side slip angle in the mixed estimator 130 using estimated values of the dynamics-based estimator 110 and the kinematics-based estimator 120.

The kinematics-based estimator 120 estimates the side slip angle change rate \dot{β}ₖᵢₙ of the vehicle using the following equation (1).

$${\dot{β}}_{kin} = \frac{{a}_{y}}{{v}_{x}} - γ \qquad ( 1 )$$

where α_{y} represents an acceleration of vehicle in a direction perpendicular to a direction of travel of the vehicle, vₓ represents a speed of the vehicle in the direction of travel of the vehicle, and γ represents a yaw rate of the vehicle.

The mixed estimator 130 estimates the final side slip angle β of the vehicle based on the estimated β_{dyn} and \dot{β}_{dyn}, and \dot{β}ₖᵢₙ.

The mixed estimator 130 may include a mixer 132 and a slip angle estimator 134.

The mixer 132 mixes the side slip angle change rate \dot{β}_{dyn} estimated by the dynamics-based estimator 110, the side slip angle change rate \dot{β}ₖᵢₙ estimated by the kinematics-based estimator 120, and the side slip angle change rate \dot{β}ₖ₋₁ in a previous operation that has been estimated by the slip angle estimator 134, and provides the mixed value to the slip angle estimator 134.

For example, the mixer 132 may average the three side slip angle change rates \dot{↑}_{dyn}, \dot{β}ₖᵢₙ, and \dot{β}ₖ₋₁ and provide their averaged value to the slip angle estimator 134 as the side slip angle change rate, or may select one of the three side slip angles and provide the selected side slip angle to the slip angle estimator 134.

The slip angle estimator 134 estimates the final side slip angle β using the dynamics-based side slip angle β_{dyn} and the side slip angle change rate \dot{β}_{dyn} received from the dynamics-based estimator 110 and the side slip angle change rate \dot{β}_{bld} received from the mixer 132.

To this end, the slip angle estimator 134 may use, for example, but not limited to, a Kalman filter.

An exemplary embodiment of a side slip angle estimation algorithm of the slip angle estimator 134 using the Kalman filter is as follows.

A state space equation model that predicts the side slip angle βₖ₊₁ and the side slip angle change rate \dot{β}ₖ₊₁ of a current operation using the side slip angle βₖ and the side slip angle change rate \dot{β}ₖ estimated in the previous operation is as the following equation (2).

$$[ \begin{matrix}{β}_{k + 1} \\ {\dot{β}}_{k + 1}\end{matrix} ] = [ \begin{matrix}1 & dt \\ 0 & 1\end{matrix} ] [ \begin{matrix}{β}_{k} \\ {\dot{β}}_{k}\end{matrix} ] \qquad ( 2 )$$

The Kalman filter predicts an estimated value and error covariance of the side slip angle, calculates a Kalman gain, and then estimates a current state value using the sensor measurement value.

The current state value xₖ may be expressed as in the following equation (3).

$${x}_{k} = [ \begin{matrix}{\hat{β}}_{k} \\ {\dot{β}}_{k}\end{matrix} ] \qquad ( 3 )$$

In an exemplary embodiment of the present disclosure, as the side slip angle change rate of a previous state value, instead of the value \dot{β}ₖ₋₁ predicted by the Kalman filter, the side slip angle change rate \dot{β}_{bld} estimated by the kinematics-based estimator 120 or the mixer 132 may be used.

Therefore, the state value of the previous operation modified based on kinematics may be expressed as the following equation (4).

$${x}_{k - 1} = [ \begin{matrix}{\hat{β}}_{k - 1} \\ {\dot{β}}_{bld}\end{matrix} ] \qquad ( 4 )$$

Using the modified previous state value, the current state value and error covariance of the side slip angle may be predicted using the following equations (5) and (6).

$$= \qquad ( 5 )$$

$${P}_{\overline{k}} = {AP}_{k - 1} {A}^{T} + Q \qquad ( 6 )$$

Here, A represents a state space equation of the Kalman filter, and Q represents noise of the state space equation.

Based on the value of P_{k̅} calculated in this way, the Kalman gain may be calculated using the following equation (7).

$${K}_{k} = {P}_{\overline{k}} {{H}^{T} ( {HP}_{\overline{k}} {H}^{T} + R )}^{- 1} \qquad ( 7 )$$

Here, R represents sensor noise, that is, noise of a measurement value, and H represents a state space equation.

Finally, using the values obtained in this way and the sensor measurement value, the final side slip angle [symbol] and the change rate [symbol] are estimated by using the following equation (8), and an error covariance value is updated using the following equation (9).

$$= + {K}_{k} ( {z}_{k} - H {x}_{\overline{k}} ) \qquad ( 8 )$$

$${P}_{k} = {P}_{\overline{k}} - {K}_{k} {HP}_{\overline{k}} \qquad ( 9 )$$

Here, zₖ represents the sensor measurement value, and in an exemplary embodiment of the present disclosure, β_{dyn} and \dot{β}_{dyn} estimated by the dynamics-based estimator 110 may be used instead of the sensor measurement value. For example, β_{dyn} and \dot{β}_{dyn} estimated by a sliding mode observer may be used instead of the measurement value.

With the final side slip angle and change rate estimated in this way as the previous state value, the final side slip angle may be continuously updated by repeating the Kalman filter using equations (4) to (9). However, by using the side slip angle change rate estimated by the kinematics-based estimator 120 instead of the estimated final side slip angle change rate, an accurate side slip angle may be more accurately estimated and the nonlinearity of the vehicle is eliminated.

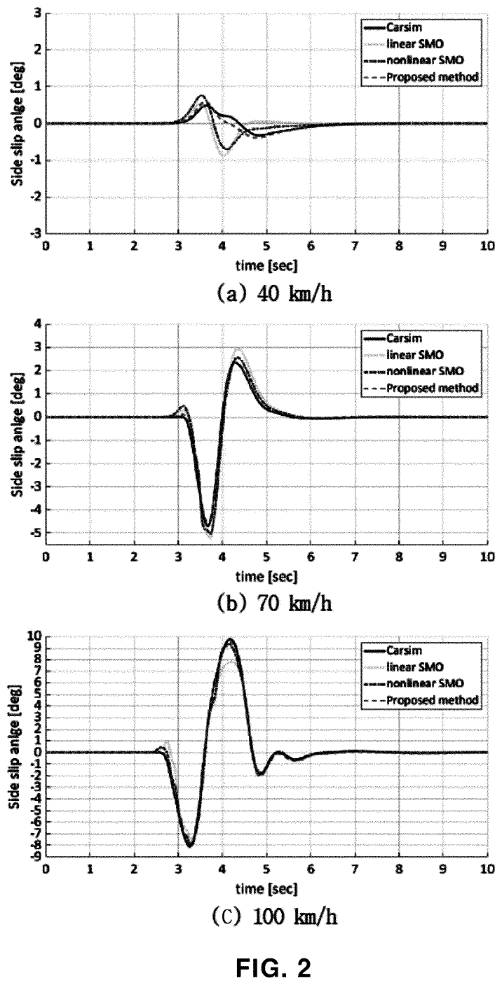

FIGS. 2(a) to 2(c) show results of comparing side slip angles estimated by the side slip angle estimator according to the present disclosure and side slip angles simulated with a vehicle model.

FIG. 2(a), FIG. 2(b), and FIG. 2(c) show comparison of result values of the side slip angle estimation at 40 km/h, at 70 km/h, and at 100 km/h, respectively.

The test was conducted in vehicle simulation environment of MATLAB (Carsim-MATLAB) under conditions of the lane change performed with a steering angle between 1 and 10 degrees.

It can be seen that results according to the present disclosure (proposed method) exhibit superior estimation performance compared to the other two sliding mode observers (linear SMO and nonlinear SMO), that is, the dynamics-based estimation method.

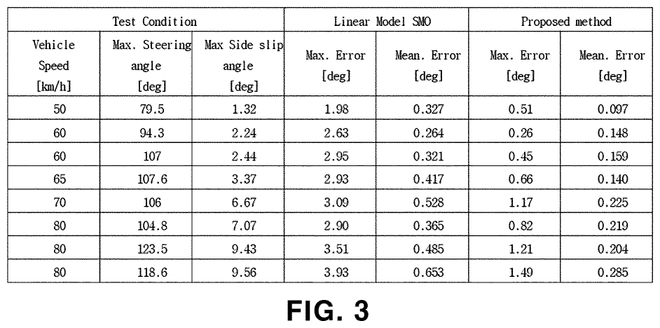

FIG. 3 shows results of comparing side slip angles estimated by the side slip angle estimator according to an embodiment of the present disclosure and side slip angles measured in an actual vehicle.

The test was conducted while performing various lane changes in a range of 50 to 100 km/h, and the side slip angle was measured from 1 to 10 degrees.

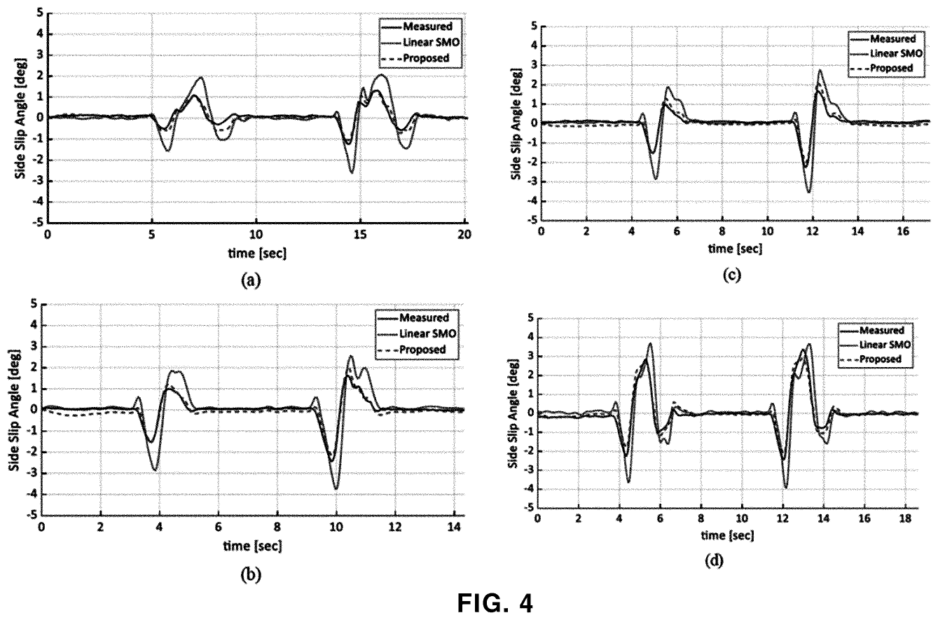

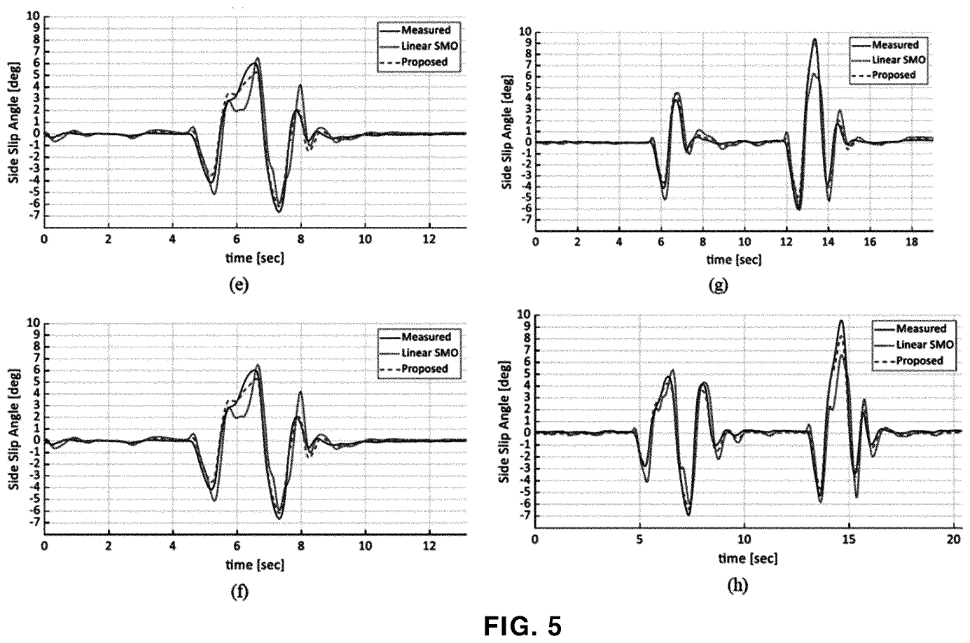

FIGS. 4 and 5 are graphs showing various test results of FIG. 3.

It can be seen that in various environments, side slip angle estimation results (proposed) according to an embodiment of the present disclosure are closer to side slip angles (measured) measured in an actual vehicle compared to side slip angle estimation results according to the linear SMO.

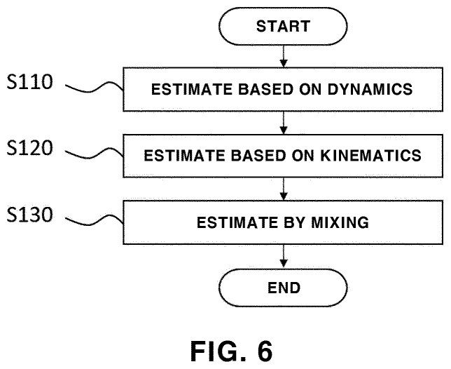

FIG. 6 is a schematic flowchart of a side slip angle estimation method according to an exemplary embodiment of the present disclosure.

The side slip angle estimation method according to an embodiment of the present disclosure may be performed by a side slip angle estimation device including one or more processors and a memory.

The side slip angle estimation method according to the present disclosure may estimate a side slip angle and a side slip angle change rate by a dynamics-based estimation operation (step S110).

Based on the dynamics, a side slip angle of a vehicle may be estimated using one or more vehicle sensor values. As described above, the side slip angle may be estimated using, for example, but not limited to, a sliding mode observer or a Kalman filter.

Next, the side slip angle change rate may be estimated based on kinematics (step S120).

The side slip angle change rate may be estimated by a speed of the vehicle in a direction of travel of the vehicle, an acceleration of the vehicle in a direction perpendicular to the direction of travel of the vehicle, and a yaw rate of the vehicle. For instance, a value obtained by subtracting the yaw rate from a value obtained by dividing the acceleration of the vehicle in a direction perpendicular to the direction of travel of the vehicle by the speed of the vehicle in the direction of travel of the vehicle may be calculated as the side slip angle change rate.

Finally, a final side slip angle may be estimated by mixing the estimated value of the side slip angle and the estimated value of the side slip angle change rate, which have been obtained in the previous operations (step S130).

Here, estimating the final side slip angle may be done by a Kalman filter.

The operation of estimating the final side slip angle by the Kalman filter is the same as or similar to the operations described above. In this case, as the measurement value used in the Kalman filter, the value estimated in the previous dynamics-based estimation operation may be used rather than the actual sensor measurement value. For example, the side slip angle and side slip angle change rate estimated by the sliding mode observer may be used.

When the state space equation of the Kalman filter is updated, the side slip angle change rate estimated in the kinematics-based estimation operation may be used instead of the side slip angle change rate estimated in the previous operation. Alternatively, a value obtained by mixing the side slip angle change rate estimated in the kinematics-based estimation operation, the side slip angle change rate estimated in the dynamics-based estimation operation, and the final side slip angle change rate estimated in the Kalman filter may be used as the side slip angle change rate.

According to some embodiments of the present disclosure, a side slip angle may be more accurately estimated by combining dynamics-based estimation and kinematics-based estimation.

In addition, according to certain embodiments of the present disclosure, lateral control of the vehicle can be more stably performed by controlling a suspension through accurate side slip angle estimation.

Meanwhile, it is added that, even though not explicitly described herein, an effect described in the specification below that is expected by the technical feature of the present disclosure and a temporary effect thereof will be treated as those described in the specification of the present disclosure.

As described above, a side slip angle estimation device and method according to certain embodiments of the present disclosure may compensate for nonlinearity of a vehicle while compensating for shortcomings of the dynamics-based estimation method and the kinematics-based estimation method, and may perform more accurate side slip prediction without complex calculations or additional costs to predict nonlinearity.

What is claimed is:

1. A side slip angle estimation device comprising:
one or more processors; and
memory configured to store instructions which, when executed by the one or more processors, cause the one or more processors to perform operations comprising:
estimating a side slip angle of a vehicle based on one or more of vehicle sensor values using dynamics;
estimating a side slip angle change rate of the vehicle based on one or more of the vehicle sensor values using kinematics; and
estimating a final side slip angle of the vehicle based on the side slip angle estimated using the dynamics and the side slip angle change rate estimated using the kinematics.

2. The side slip angle estimation device of claim 1, wherein the one or more processors are configured to estimate the side slip angle using the dynamics by a sliding mode observer.

3. The side slip angle estimation device of claim 1, wherein the one or more processors are configured to estimate the side slip angle using the dynamics by a Kalman filter.

4. The side slip angle estimation device of claim 1, wherein the one or more processors are configured to estimate the side slip angle change rate based on a speed of the vehicle in a direction of travel of the vehicle, an acceleration of the vehicle in a direction perpendicular to the direction of travel of the vehicle, and a yaw rate of the vehicle using the kinematics.

5. The side slip angle estimation device of claim 4, wherein the one or more processors are configured to calculate the side slip angle change rate by subtracting the yaw rate of the vehicle from a value obtained by dividing the acceleration of the vehicle in the direction perpendicular to the direction of travel of the vehicle by the speed of the vehicle in the direction of travel of the vehicle.

6. The side slip angle estimation device of claim 1, wherein the one or more processors are configured to estimate the final side slip angle of the vehicle using a side slip angle change rate obtained by mixing a dynamic side slip angle change rate estimated using the dynamics and a kinematic side slip angle change rate estimated using the kinematics.

7. The side slip angle estimation device of claim 1, wherein the one or more processors are configured to estimate the final side slip angle of the vehicle using a Kalman filter.

8. The side slip angle estimation device of claim 7, wherein the one or more processors are configured to estimate the final side slip angle of the vehicle by using a dynamic side slip angle and a dynamic side slip angle change rate calculated by a sliding mode observer as measurement values to be used in the Kalman filter.

9. The side slip angle estimation device of claim 7, wherein one or more processors are configured to, when a state space equation model of the Kalman filter is updated, estimate the final side slip angle of the vehicle by using the side slip angle change rate estimated using the kinematics instead of a final side slip angle change rate calculated in a previous operation.

10. The side slip angle estimation device of claim 7, wherein the one or more processors are configured to, when a state space equation model of the Kalman filter is updated, estimate the final side slip angle of the vehicle based on a side slip angle change rate calculated by mixing a dynamic side slip angle change rate estimated using the dynamics and a kinematic side slip angle change rate estimated using the kinematics instead of a final side slip angle change rate calculated in a previous operation.

11. A side slip angle estimation method comprising:
estimating a side slip angle of a vehicle based on one or more of vehicle sensor values using dynamics;
estimating a side slip angle change rate of the vehicle based on one or more of the vehicle sensor values using kinematics; and
estimating a final side slip angle of the vehicle based on the side slip angle estimated using the dynamics and the side slip angle change rate estimated using the kinematics.

12. The side slip angle estimation method of claim 11, wherein the estimating of the side slip angle of the vehicle using the dynamics comprises the side slip angle of the vehicle a sliding mode observer.

13. The side slip angle estimation method of claim 11, wherein the estimating of the side slip angle of the vehicle using the dynamics comprises the side slip angle of the vehicle by a Kalman filter.

14. The side slip angle estimation method of claim 11, wherein the estimating of the side slip angle change rate of the vehicle using the kinematics comprises estimating the side slip angle change rate of the vehicle based on a speed of the vehicle in a direction of travel of the vehicle, an acceleration of the vehicle in a direction perpendicular to the direction of travel of the vehicle, and a yaw rate of the vehicle using the kinematics.

15. The side slip angle estimation method of claim 14, wherein the estimating of the side slip angle change rate of the vehicle using the kinematics comprises calculating the side slip angle change rate by subtracting the yaw rate of the vehicle from a value obtained by dividing the acceleration of the vehicle in the direction perpendicular to the direction of travel of the vehicle by the speed of the vehicle in the direction of travel of the vehicle.

16. The side slip angle estimation method of claim 11, wherein the estimating of the final side slip angle comprises estimating the final side slip angle of the vehicle using a side slip angle change rate obtained by mixing a dynamic side slip angle change rate estimated using the dynamics and a kinematic side slip angle change rate estimated using the kinematics.

17. The side slip angle estimation method of claim 11, wherein the estimating of the final side slip angle comprises estimating the final side slip angle of the vehicle using a Kalman filter.

18. The side slip angle estimation method of claim 17, wherein the estimating of the final side slip angle comprises estimating the final side slip angle of the vehicle by using a dynamic side slip angle and a dynamic side slip angle change rate calculated by a sliding mode observer as measurement values to be used in the Kalman filter.

19. The side slip angle estimation method of claim 17, wherein the estimating of the final side slip angle comprises, when a state space equation model of the Kalman filter is updated, estimating the final side slip angle of the vehicle by using a kinematic side slip angle change rate estimated based on the kinematics instead of a final side slip angle change rate calculated in a previous operation.

20. The side slip angle estimation method of claim 17, wherein the estimating of the final side slip angle comprises, when a state space equation model of the Kalman filter is updated, estimating the final side slip angle of the vehicle based on a side slip angle change rate calculated by mixing a dynamic side slip angle change rate estimated using the dynamics and a kinematic side slip angle change rate estimated using the kinematics instead of a final side slip angle change rate calculated in a previous operation.
